(19) United States
(12) Patent Application Publication
(10) Pub. No.: US 2001/0035457 A1
(43) Pub. Date: Nov. 1, 2001

(54) Customer postage bar coding unit

(76) Inventor: Patricia Christine Friend, Cerritos, CA (US)

Correspondence Address: Matthew J. Peirce, Esq., 1550 Starlight Canyon Avenue, Las Vegas, NV, 89123, US

(21) Appl. No.: 09/849,679

(22) Filed: May 4, 2001

Related U.S. Application Data
(60) Provisional application No. 60/202,048, filed on May 5, 2000.

(51) Int. Cl. G06K 5/00

(52) U.S. Cl. 235/380

(57) ABSTRACT

A new and improved machine is disclosed where customers could use their ATM card to pay for postage and place bar codes on their mail. The machine would first be activated by a user once a user had inserted their ATM card and typed in their personal identification number (PIN). Then, the machine would ask a user what mail type they would have, such as first-class or bulk, and then determine the weight of the package. The machine would then ask the user for their zip code. Once the zip code would be keyed, mail would be accepted, postaged, barcoded, and dropped into a bin inside the machine, where it would remain until retrieved by a postal employee.

### I. BACKGROUND OF THE INVENTION

The present invention concerns that of a new and improved machine which would allow customers to use their ATM card to pay for postage, place bar codes on their mail, and weigh inputted mail and packages with scales for proper postage amount determination.

### II. DESCRIPTION OF THE PRIOR ART

U.S. Pat. No. 5,826,246, issued to Bator et al., discloses a postage metering capability which is integrated into an automated teller machine.

U.S. Pat. No. 5,313,404, issued to Wu, discloses an automatic postal teller machine capable of automatically performing the postal operation in an unmanned condition.

U.S. Pat. No. 4,940,887, issued to Sheng-Jung et al., discloses a computerized handling device which automatically processes mail items.

### III. SUMMARY OF THE INVENTION

The present invention concerns that of a new and improved machine where customers could use their ATM card to pay for postage and place bar codes on their mail. The machine of the present invention would first be activated by a user once a user had inserted their ATM card and typed in their personal identification number (PIN). Then, the machine would ask a user what mail type they would have, such as first-class, second-class, or bulk, and then determine the weight of the package. The machine would then ask the user for their zip code. Once the zip code would be keyed, mail would be accepted, postaged, barcoded, and dropped into a bin inside the machine, where it would remain until retrieved by a postal employee.

There has thus been outlined, rather broadly, the more important features of a mail-handling machine in order that the detailed description thereof that follows may be better understood and in order that the present contribution to the art may be better appreciated. There are, of course, additional features of the mail-handling machine that will be described hereinafter and which will form the subject matter of the claims appended hereto.

In this respect, before explaining at least one embodiment of the mail-handling machine in detail, it is to be understood that the mail-handling machine is not limited in its application to the details of construction and to the arrangements of the components set forth in the following description or illustrated in the drawings. The mail-handling machine is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present mail-handling machine. It is important, therefore, that the claims be regard as including such equivalent constructions insofar as they do not depart from the spirit and scope of the present invention.

It is therefore an object of the present invention to provide a mail-handling machine which has all of the advantages of the prior art and none of the disadvantages.

It is another object of the present invention to provide a mail-handling machine which may be easily and efficiently manufactured and marketed.

It is another object of the present invention to provide a mail-handling machine which is of durable and reliable construction.

It is yet another object of the present invention to provide a mail-handling machine which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 is a front view of the present invention.

### V. DESCRIPTION OF THE PREFERRED EMBODIMENT

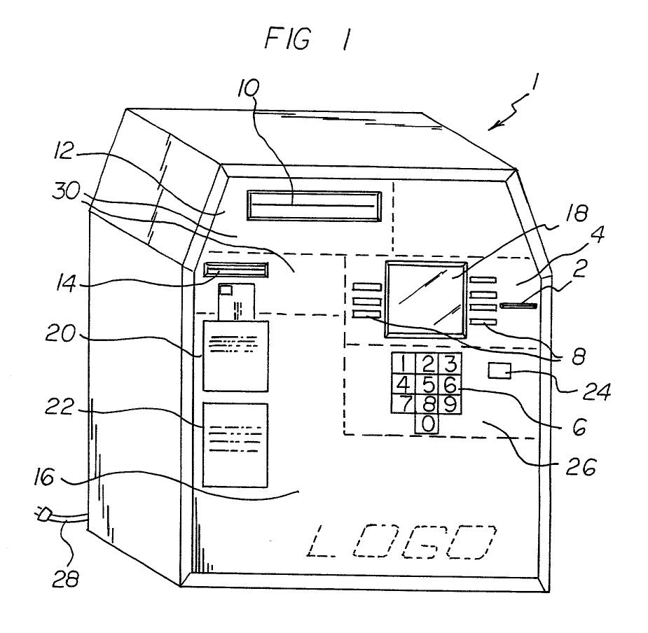

FIG. 1 shows a front view of customer postage bar coding unit 1, which would be in the shape of a large box. Customer postage bar coding unit 1 would have a front face and a rear face, two side faces, a left side face and a right side face, a top face, and a bottom face. Internally, customer postage bar coding unit 1 would include bulk mail bin 12 and first class mail bin 16. Bulk mail bin 12 would be located in approximately the upper ⅕ of the internal space within customer postage bar coding unit 1, while first class mail bin would be located in approximately the lower ⅗ of customer postage bar coding unit 1.

The front face of customer postage bar coding unit 1 is designed to be interactive with a user. On the front face of customer postage bar coding unit 1 near the right side face, the present invention would include ATM card slot 2, numerical keypad 6, an LED screen 18, and a plurality of side-mounted buttons 8 located on both sides of LED screen 18. The LED screen 18 would be designed to ask questions to a user and show various input that a user would type in on numerical keypad 6.

The plurality of side-mounted buttons 8 would include “yes” and “no” buttons, along with other buttons to facilitate the entry of the necessary data into the present invention. The present invention would be initially activated by a user inserting an ATM card into ATM card slot 2. Once this would happen, ATM computer 4, which would be internally located within the present invention immediately behind ATM card slot 2, would take ahold of the user's ATM card and activate the present invention to go through a series of questions for further input from a user.

The present invention would also include a front-mounted bulk mail slot 10 on the front face of the present invention near the juncture where the front face meets the top face of the present invention. Bulk mail slot 10 would be located immediately in front of bulk mail bin 12, allowing mail that a user inserts through bulk mail slot 10 to be eventually placed within bulk mail bin 12 after it has been properly processed.

The present invention would also include a front-mounted first class mail slot 14 on the front face of the present invention in the upper left hand comer of the present invention. First class mail slot 14 would be located immediately in front of first class mail bin 16, allowing mail that a user inserts through first class mail slot 14 to be eventually placed within first class mail bin 16 after it has been properly processed.

The present invention would also include front-mounted direction plate 20 and priority mail direction plate 22 on the front surface of the present invention. Each of these direction plates would give appropriate directions to a user so that a user could properly proceed to get proper postage on the present invention.

The present invention would also include a zoom mail selection key 24, which would preferably be located on the front face of the present invention. Zoom mail selection key 24 is for customers who have a large amount of the same type of mail. Zoom mail selection key 24 would allow a user to hurry along the process so other customers would not have wait nearly as long. Once a user would select this option, a user would only have to input the individual zip code for each piece of mail, allowing the present invention to function more quickly and efficiently.

The present invention would also include an internal central processing unit 26, or CPU 26. CPU 26 would control ATM computer 4 and a pair of postage meters 30, one of which would be located behind front bulk mail slot 10 and the other, which would be located behind first class mail slot 14. CPU 26 would control all other electronic circuitry in the present invention. CPU 26 would be powered by power receiving means 28, which would be preferably be an electrical plug which would be hooked up to standard alternating electrical current. Each postage meter 30 would label (if colored mail), weight, post, and barcode each piece of mail inserted into either bulk mail slot 10 or first class mail slot 14.

When a user would desire to use the present invention, the user would go through the following steps:

1. The user would insert an ATM card into ATM card slot 2.

2. LED screen 18 would ask if the piece of mail in question is white or has color. The customer would then select one or the other.

3. LED screen 18 would then ask the customer if the mail is first class or bulk mail. (Show on screen either weight or size chart).

4. LED screen 18 would then ask if a particular piece of mail would have a bar code. In order to assist a user in determining this question, LED screen 18 would show a picture of a letter with a bar code in red on the bottom of a letter to let the customer know what a bar code is. If the bar code would be present, the present invention would be able to read the bar code. If no bar code was present, LED screen would then prompt the user to key in the zip code with numerical keypad 6.

5. LED screen 18 would then ask the customer if they need postage.

6. LED screen 18 would then instruct the customer which slot to put mail in for postage and barcoding.

7. The respective postage meter 30 would weigh, post, barcode white mail, and would label, weigh, post, and barcode colored mail. The respective postage meter 30 would then drop mail into the appropriate bin.

8. The customer would repeat the above process for each piece of mail until he or she would be done with his or her mail. If successive pieces of mail would be the same, a user could use zoom mail selection key 24 to help speed the process along with placing appropriate postage on large volumes of mail.

What I claim as my invention is:

1. A mail-handling machine comprising:
(a) an outer box frame, the box frame having a front face and a rear face, the box frame further including two side faces, a left side face and a right side face, the box frame further including a top face and a bottom face,
(b) a bulk mail bin located within the outer box frame, the bulk mail bin occupying approximately the upper ⅕ of the volume within the outer box frame,
(c) a first slot located on the front face of the outer box frame in front of the location of where the bulk mail bin would be located,
(d) a first postage meter located within the outer box frame immediately adjacent to and above the bulk mail bin, the first postage meter located immediately adjacent to the first slot, the first postage meter designed to weigh, post, and barcode each item of mail inserted through the first slot, the first postage meter further designed to subsequently cause each piece of mail to be deposited within the bulk mail bin,
(e) a first class mail bin located within the outer box frame, the first class mail bin occupying approximately the lower ⅗ of the volume within the outer box frame,
(f) a second slot located on the front face of the outer box frame in front of the location of where the first class mail bin would be located,
(g) a second postage meter located within the outer box frame immediately adjacent to and above the first class mail bin, the second postage meter located immediately adjacent to the second slot, the second postage meter designed to weigh, post, and barcode each item of mail inserted through the second slot, the second postage meter further designed to subsequently cause each piece of mail to be deposited within the first class mail bin,
(h) an ATM slot for receiving ATM cards, the ATM slot located on the front face of the box frame,
(i) an ATM computer for processing an ATM card inputted through the ATM slot, the ATM computer further acting to deduct monetary amounts from an ATM card for any postage applied by the first postage meter or second postage meter,
(j) a central processing unit located within the box frame, the central processing unit serving as the computer memory for the mail-handling machine, the central processing unit electronically connected to the ATM computer, the central processing unit further electronically connected to the first postage meter and the second postage meter,
(k) a numerical keypad located on the front face of the box frame for receiving input from a user, the numerical keypad electronically connected to the central processing unit,
(l) an LED screen on the front face of the box frame for viewing output from the mail-handling machine, the LED screen electronically connected to the central processing unit,
(m) a plurality of additional buttons mounted on the front face of the box frame, the plurality of additional buttons electronically connected to the central processing unit, the plurality of additional buttons including at least one button marked “yes” and one button marked “no” for input use by a user,
(n) power means to provide power to the mail-handling machine,
(o) whereby the mail-handling machine operates a process for identifying, sorting, and placing postage on an item to be mailed.

2. A mail-handling machine according to claim 1 wherein the process for identifying, sorting, and placing postage on an item to be mailed comprises the steps of:
(a) A user inserting an ATM card into the ATM slot and typing in their PIN number on the numerical keypad,
(b) inquiring whether a particular item to be mailed would be white or colored,
(c) inquiring whether a particular item to be mailed would be sent bulk mail or first class mail,
(d) inquiring whether a particular item to be mailed already possesses a bar code,
(e) requesting that a user input the zip code for a particular item to be mailed if no bar code is present on that particular item to be mailed,
(f) inquiring whether the customer would need postage for a particular item to be mailed,
(g) instructing the customer the correct slot to input the mail into if no postage is present so that the item to be mailed can be posted and barcoded,
(h) weighing, posting, and barcoding the item to be mailed of the item to be mailed is white in color,
(i) labeling, weighing, posting, and barcoding the item to be mailed of the item to be mailed is colored,
(j) deducting any postage placed on each item to be mailed from a financial account linked to the ATM card inserted through the ATM slot, and
(k) dropping the item to be mailed into the correct mail bin for later retrieval.
